(19) United States
(12) Patent Application Publication
(10) Pub. No.: US 2022/0038282 A1
(43) Pub. Date: Feb. 3, 2022

(54) Secure Token Transfer between Untrusted Entities

(71) Applicant: Citrix Systems, Inc., Fort Lauderdale, FL (US)

(72) Inventors: Harold Teramoto, Margate, FL (US); Ashish Gujarathi, Parkland, FL (US); Vikas Nambiar, Pembroke Pines, FL (US)

(21) Appl. No.: 16/941,001

(22) Filed: Jul. 28, 2020

(51) Int. Cl. H04L 9/32; H04L 9/08

(52) U.S. Cl. CPC H04L 9/3213; H04L 9/0819; H04L 9/0894; H04L 9/0877

(57) ABSTRACT

Methods and systems for providing a token to a protected portion of a computing device are described herein. A computing device may comprise a first portion and a second portion, and the second portion may be prevented by a security policy from interacting with the first portion. A server may receive, from a first application executing on a first portion of the computing device, a token. The server may generate a key based on the token. The server may send the key to a second portion of the computing device. The second portion of the computing device may send a request for the token, and the request may comprise the key. The server may send the token to the second portion of the computing device. The token may be encrypted such that the unencrypted token is not available to the server.

### FIELD

Aspects described herein generally relate to computer networking, enterprise mobility management, and hardware and software related thereto. More specifically, one or more aspects describe herein provide for securely transferring tokens between untrusted entities, such as a protected and unprotected portion of a computing device.

### BACKGROUND

Computing devices may use tokens as part of an authentication process. For example, after a client computing device is authenticated, a server may provide the computing device with a temporary token which permits the client computing device to access content on the server for a predetermined period of time. Tokens are generally configured to be temporary and specific to a particular user and/or computing device. For example, a token might expire after twenty-four hours and might only provide a particular computing device (e.g., a computing device associated with a successful prior authentication) access to content.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards providing a token to a protected portion of a computing device.

A server may receive, from a first application executing on a first portion of a computing device, a token. The server may generate a key corresponding to the token. Generating the key may comprise receiving, from the computing device, user input comprising at least a portion of the key. Generating the key may be based on determining that the key is not represented in a database. Generating the key may comprise compiling a second application comprising the key. Compiling the second application may comprise signing the second application with the key. The server may store the token and the key in a database. The token and/or the key may be stored in the database such that the database is configured to delete the token after a predetermined time period. The server may send, to a second portion of the computing device, the key. The second portion of the computing device may be prevented, by a security policy, from interacting with the first portion of the computing device. The server may receive, from the second portion of the computing device, a request for the token. The request may comprise the key. The server may retrieve, from the database and using the key, the token. Retrieving the token may comprise querying, using the key and a user identifier associated with the computing device, the database for the token. The server may send the token to the second portion of the computing device. Sending the token to the second portion of the computing device may comprise sending a second application comprising the key to the second portion of the computing device. Sending the key may additionally and/or alternatively comprise sending, to a mobile device management application configured to manage the second portion of the computing device, the key. Sending the key may additionally and/or alternatively comprise sending, to the second portion of the computing device, a Uniform Resource Locator (URL) which, when accessed by a web browser executing in the second portion of the computing device, provides the key.

A first application executing on a first portion of a computing device may send, to a server, a token. The token may be encrypted (e.g., using a key) before it is sent to the server, such that the server might not have access to the unencrypted version of the token. A second portion of the computing device may be prevented (e.g., by a security policy) from interacting with the first portion of the computing device. The second portion of the computing device may send, to the server, a request for the token. Sending the request for the token may comprise executing a second application, such that the second application is configured to send the request for the token. Sending the request for the token may comprise receiving, via a second application executing in the second portion of the computing device, user input comprising at least a portion of a key used to encrypt the token. The second portion of the computing device may receive, from the server, the token. If the token is encrypted, the token may be decrypted using, e.g., the key.

A server may receive, from a first application executing on a first portion of a computing device, a token. A key may be generated after receiving the token. The server may sign a second application with a key corresponding to the token. The server may receive, from the computing device, user input comprising at least a portion of the key. Signing the second application may comprise compiling the second application with the key. The token and the key may be stored, and the token and the key may be deleted after a predetermined time period. The server may cause a second portion of the computing device to execute the second application. The second portion of the computing device may be prevented, by a security policy, from interacting with the first portion of the computing device. The server may receive, from the second application, a request for the token. The request for the token may comprise at least a portion of the key. The server may send, to the second portion of the computing device, the token.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5 depicts an illustrative enterprise mobility management system.

FIG. 6 depicts another illustrative enterprise mobility management system.

FIG. 7 depicts a computing device with multiple portions, a server, and a storage device.

FIG. 8 depicts steps which may be taken by a computing device, a server, and a storage device.

FIG. 9 depicts steps which may be taken by a computing device, a server, and a storage device, including steps where a key is displayed to users.

FIG. 10 depicts steps which may be taken by a computing device, a server, and a storage device, including steps where a user provides all or portions of a key.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

Computing devices might maintain protected and unprotected areas of their operating system. For example, a computing device may maintain a protected environment of the operating system which may be prevented from communicating with any other content (e.g., applications, files) not in the sandboxed environment of the operating system. This may advantageously make the protected environment quite secure. That said, because the protected environment may be kept segregated from other portions of the computing device and be incapable of communicating with those other portions of the computing device, user experience may suffer. For example, if a user authenticates with a server in the unprotected portion of the computing device, then a single sign-on token received based on that authentication might not be transferrable to the protected portion of the computing device, and vice versa. This can be particularly cumbersome to users when performing initialization steps in the unprotected environment that are associated with the protected environment. For example, as part of setting up a mobile device management system on a computing device, a user might use an application executing in an unprotected portion of their computing device to authenticate themselves with a company server, receiving a token reflecting their successful authentication. The company server may then establish a mobile device management framework on the user's computing device, including causing the computing device to maintain a protected environment. The user might then be forced to re-login in the protected environment, as the protected environment would be incapable of receiving the token from the unprotected environment. From the user's perspective, this may be perceived as an error, an annoyance, or the like.

As a general introduction to the subject matter described in more detail below, aspects described herein are directed towards transferring tokens, such as single sign-on tokens, between untrusted entities. A server may receive, from a first application executing on a first portion of a computing device, a token. The server may generate a key corresponding to the token. Generating the key may comprise receiving, from the computing device, user input comprising at least a portion of the key. Generating the key may be based on determining that the key is not represented in a database. Generating the key may comprise compiling a second application comprising the key. Compiling the second application may comprise signing the second application with the key. The server may store the token and the key in a database. The token and/or the key may be stored in the database such that the database is configured to delete the token after a predetermined time period. The server may send, to a second portion of the computing device, the key. The second portion of the computing device may be prevented, by a security policy, from interacting with the first portion of the computing device. The server may receive, from the second portion of the computing device, a request for the token. The request may comprise the key. The server may retrieve, from the database and using the key, the token. Retrieving the token may comprise querying, using the key and a user identifier associated with the computing device, the database for the token. The server may send the token to the second portion of the computing device. Sending the token to the second portion of the computing device may comprise sending a second application comprising the key to the second portion of the computing device. Sending the key may additionally and/or alternatively comprise sending, to a mobile device management application configured to manage the second portion of the computing device, the key. Sending the key may additionally and/or alternatively comprise sending, to the second portion of the computing device, a Uniform Resource Locator (URL) which, when accessed by a web browser executing in the second portion of the computing device, provides the key.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled” and similar terms, is meant to include both direct and indirect connecting and coupling.

Computing Architecture

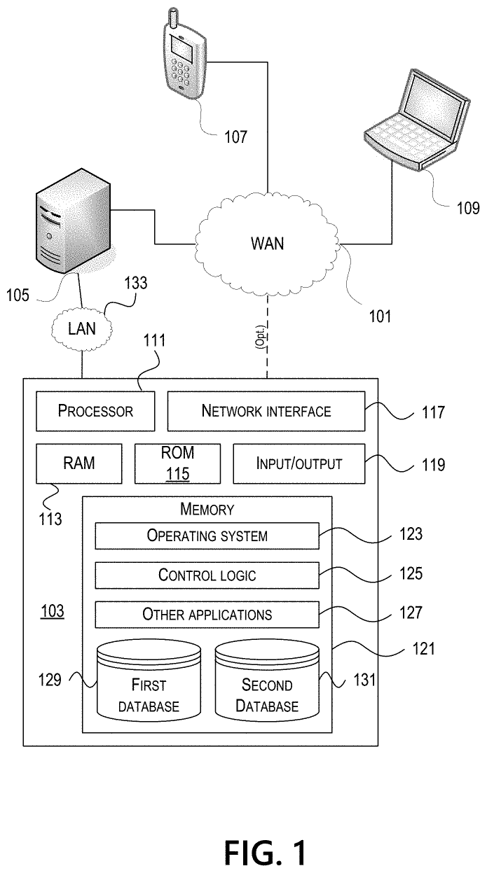

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

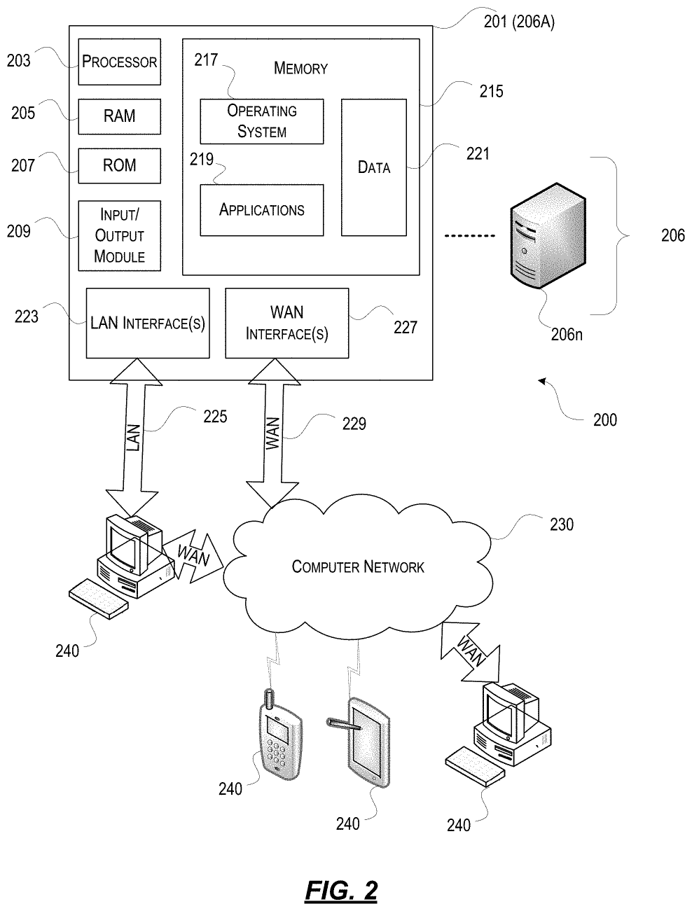

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

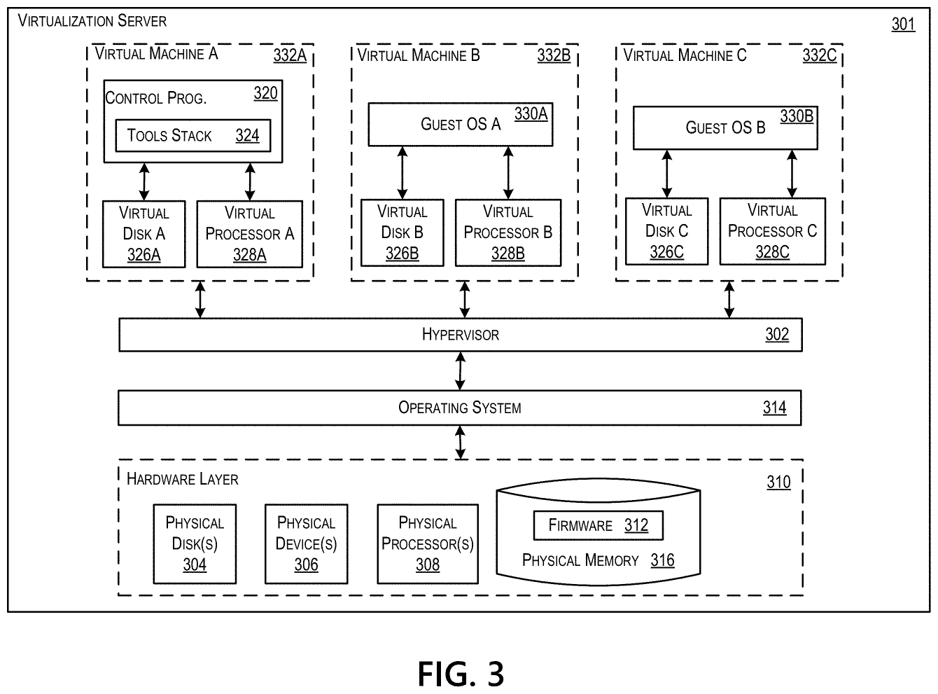

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, Calif.; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

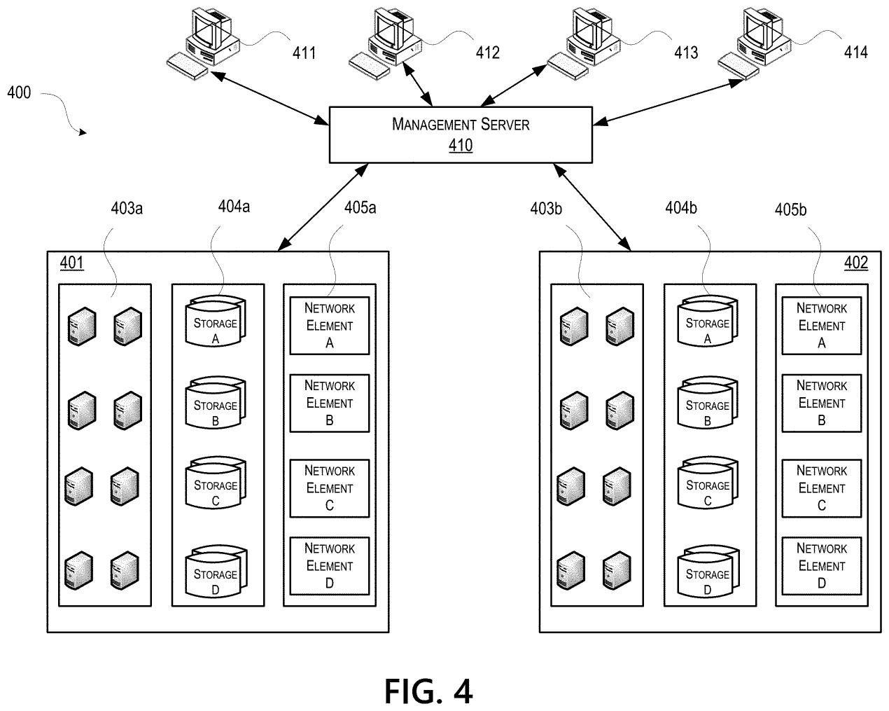

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, Fla., or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Wash.), AMAZON EC2 (Amazon.com Inc. of Seattle, Wash.), IBM BLUE CLOUD (IBM Corporation of Armonk, N.Y.), or others.

Enterprise Mobility Management Architecture

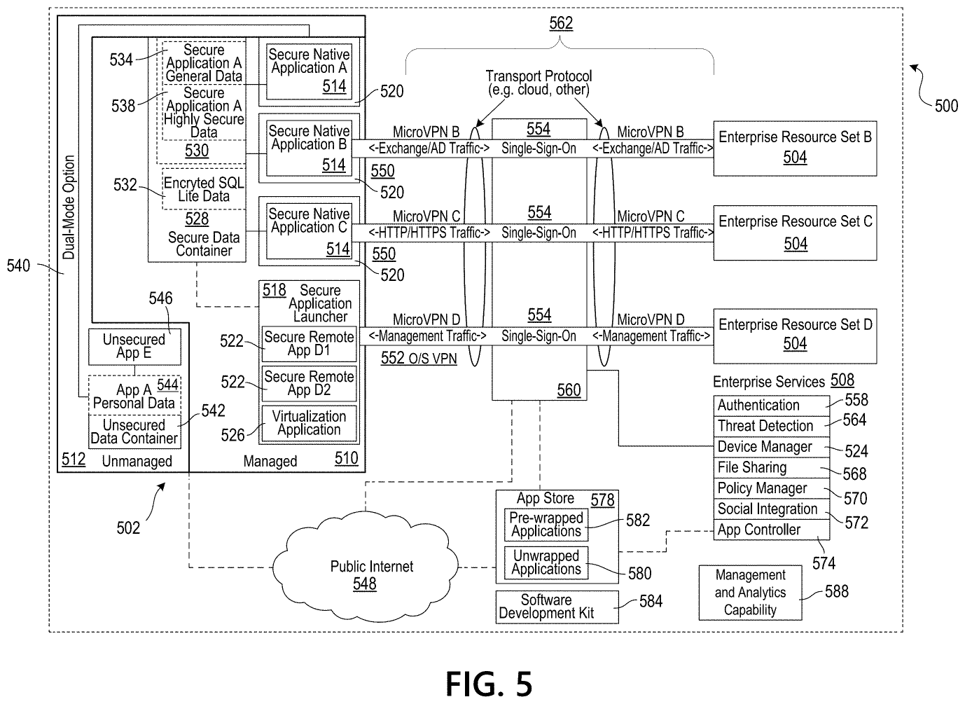

FIG. 5 represents an enterprise mobility technical architecture 500 for use in a “Bring Your Own Device” (BYOD) environment. The architecture enables a user of a mobile device 502 to both access enterprise or personal resources from a mobile device 502 and use the mobile device 502 for personal use. The user may access such enterprise resources 504 or enterprise services 508 using a mobile device 502 that is purchased by the user or a mobile device 502 that is provided by the enterprise to the user. The user may utilize the mobile device 502 for business use only or for business and personal use. The mobile device 502 may run an iOS operating system, an Android operating system, or the like. The enterprise may choose to implement policies to manage the mobile device 502. The policies may be implemented through a firewall or gateway in such a way that the mobile device 502 may be identified, secured or security verified, and provided selective or full access to the enterprise resources (e.g., 504 and 508.) The policies may be mobile device management policies, mobile application management policies, mobile data management policies, or some combination of mobile device, application, and data management policies. A mobile device 502 that is managed through the application of mobile device management policies may be referred to as an enrolled device.

In some embodiments, the operating system of the mobile device 502 may be separated into a managed partition 510 and an unmanaged partition 512. The managed partition 510 may have policies applied to it to secure the applications running on and data stored in the managed partition 510. The applications running on the managed partition 510 may be secure applications. In other embodiments, all applications may execute in accordance with a set of one or more policy files received separate from the application, and which define one or more security parameters, features, resource restrictions, and/or other access controls that are enforced by the mobile device management system when that application is executing on the mobile device 502. By operating in accordance with their respective policy file(s), each application may be allowed or restricted from communications with one or more other applications and/or resources, thereby creating a virtual partition. Thus, as used herein, a partition may refer to a physically partitioned portion of memory (physical partition), a logically partitioned portion of memory (logical partition), and/or a virtual partition created as a result of enforcement of one or more policies and/or policy files across multiple applications as described herein (virtual partition). Stated differently, by enforcing policies on managed applications, those applications may be restricted to only be able to communicate with other managed applications and trusted enterprise resources, thereby creating a virtual partition that is not accessible by unmanaged applications and devices.

The secure applications may be email applications, web browsing applications, software-as-a-service (SaaS) access applications, Windows Application access applications, and the like. The secure applications may be secure native applications 514, secure remote applications 522 executed by a secure application launcher 518, virtualization applications 526 executed by a secure application launcher 518, and the like. The secure native applications 514 may be wrapped by a secure application wrapper 520. The secure application wrapper 520 may include integrated policies that are executed on the mobile device 502 when the secure native application 514 is executed on the mobile device 502. The secure application wrapper 520 may include meta-data that points the secure native application 514 running on the mobile device 502 to the resources hosted at the enterprise (e.g., 504 and 508) that the secure native application 514 may require to complete the task requested upon execution of the secure native application 514. The secure remote applications 522 executed by a secure application launcher 518 may be executed within the secure application launcher 518. The virtualization applications 526 executed by a secure application launcher 518 may utilize resources on the mobile device 502, at the enterprise resources 504, and the like. The resources used on the mobile device 502 by the virtualization applications 526 executed by a secure application launcher 518 may include user interaction resources, processing resources, and the like. The user interaction resources may be used to collect and transmit keyboard input, mouse input, camera input, tactile input, audio input, visual input, gesture input, and the like. The processing resources may be used to present a user interface, process data received from the enterprise resources 504, and the like. The resources used at the enterprise resources 504 by the virtualization applications 526 executed by a secure application launcher 518 may include user interface generation resources, processing resources, and the like. The user interface generation resources may be used to assemble a user interface, modify a user interface, refresh a user interface, and the like. The processing resources may be used to create information, read information, update information, delete information, and the like. For example, the virtualization application 526 may record user interactions associated with a graphical user interface (GUI) and communicate them to a server application where the server application will use the user interaction data as an input to the application operating on the server. In such an arrangement, an enterprise may elect to maintain the application on the server side as well as data, files, etc. associated with the application. While an enterprise may elect to “mobilize” some applications in accordance with the principles herein by securing them for deployment on the mobile device 502, this arrangement may also be elected for certain applications. For example, while some applications may be secured for use on the mobile device 502, others might not be prepared or appropriate for deployment on the mobile device 502 so the enterprise may elect to provide the mobile user access to the unprepared applications through virtualization techniques. As another example, the enterprise may have large complex applications with large and complex data sets (e.g., material resource planning applications) where it would be very difficult, or otherwise undesirable, to customize the application for the mobile device 502 so the enterprise may elect to provide access to the application through virtualization techniques. As yet another example, the enterprise may have an application that maintains highly secured data (e.g., human resources data, customer data, engineering data) that may be deemed by the enterprise as too sensitive for even the secured mobile environment so the enterprise may elect to use virtualization techniques to permit mobile access to such applications and data. An enterprise may elect to provide both fully secured and fully functional applications on the mobile device 502 as well as a virtualization application 526 to allow access to applications that are deemed more properly operated on the server side. In an embodiment, the virtualization application 526 may store some data, files, etc. on the mobile device 502 in one of the secure storage locations. An enterprise, for example, may elect to allow certain information to be stored on the mobile device 502 while not permitting other information.

In connection with the virtualization application 526, as described herein, the mobile device 502 may have a virtualization application 526 that is designed to present GUIs and then record user interactions with the GUI. The virtualization application 526 may communicate the user interactions to the server side to be used by the server side application as user interactions with the application. In response, the application on the server side may transmit back to the mobile device 502 a new GUI. For example, the new GUI may be a static page, a dynamic page, an animation, or the like, thereby providing access to remotely located resources.

The secure applications 514 may access data stored in a secure data container 528 in the managed partition 510 of the mobile device 502. The data secured in the secure data container may be accessed by the secure native applications 514, secure remote applications 522 executed by a secure application launcher 518, virtualization applications 526 executed by a secure application launcher 518, and the like. The data stored in the secure data container 528 may include files, databases, and the like. The data stored in the secure data container 528 may include data restricted to a specific secure application 530, shared among secure applications 532, and the like. Data restricted to a secure application may include secure general data 534 and highly secure data 538. Secure general data may use a strong form of encryption such as Advanced Encryption Standard (AES) 128-bit encryption or the like, while highly secure data 538 may use a very strong form of encryption such as AES 256-bit encryption. Data stored in the secure data container 528 may be deleted from the mobile device 502 upon receipt of a command from the device manager 524. The secure applications (e.g., 514, 522, and 526) may have a dual-mode option 540. The dual mode option 540 may present the user with an option to operate the secured application in an unsecured or unmanaged mode. In an unsecured or unmanaged mode, the secure applications may access data stored in an unsecured data container 542 on the unmanaged partition 512 of the mobile device 502. The data stored in an unsecured data container may be personal data 544. The data stored in an unsecured data container 542 may also be accessed by unsecured applications 546 that are running on the unmanaged partition 512 of the mobile device 502. The data stored in an unsecured data container 542 may remain on the mobile device 502 when the data stored in the secure data container 528 is deleted from the mobile device 502. An enterprise may want to delete from the mobile device 502 selected or all data, files, and/or applications owned, licensed or controlled by the enterprise (enterprise data) while leaving or otherwise preserving personal data, files, and/or applications owned, licensed or controlled by the user (personal data). This operation may be referred to as a selective wipe. With the enterprise and personal data arranged in accordance to the aspects described herein, an enterprise may perform a selective wipe.

The mobile device 502 may connect to enterprise resources 504 and enterprise services 508 at an enterprise, to the public Internet 548, and the like. The mobile device 502 may connect to enterprise resources 504 and enterprise services 508 through virtual private network connections. The virtual private network connections, also referred to as microVPN or application-specific VPN, may be specific to particular applications (as illustrated by microVPNs 550, particular devices, particular secured areas on the mobile device (as illustrated by O/S VPN 552), and the like. For example, each of the wrapped applications in the secured area of the mobile device 502 may access enterprise resources through an application specific VPN such that access to the VPN would be granted based on attributes associated with the application, possibly in conjunction with user or device attribute information. The virtual private network connections may carry Microsoft Exchange traffic, Microsoft Active Directory traffic, HyperText Transfer Protocol (HTTP) traffic, HyperText Transfer Protocol Secure (HTTPS) traffic, application management traffic, and the like. The virtual private network connections may support and enable single-sign-on authentication processes 554. The single-sign-on processes may allow a user to provide a single set of authentication credentials, which are then verified by an authentication service 558. The authentication service 558 may then grant to the user access to multiple enterprise resources 504, without requiring the user to provide authentication credentials to each individual enterprise resource 504.

The virtual private network connections may be established and managed by an access gateway 560. The access gateway 560 may include performance enhancement features that manage, accelerate, and improve the delivery of enterprise resources 504 to the mobile device 502. The access gateway 560 may also re-route traffic from the mobile device 502 to the public Internet 548, enabling the mobile device 502 to access publicly available and unsecured applications that run on the public Internet 548. The mobile device 502 may connect to the access gateway via a transport network 562. The transport network 562 may use one or more transport protocols and may be a wired network, wireless network, cloud network, local area network, metropolitan area network, wide area network, public network, private network, and the like.

The enterprise resources 504 may include email servers, file sharing servers, SaaS applications, Web application servers, Windows application servers, and the like. Email servers may include Exchange servers, Lotus Notes servers, and the like. File sharing servers may include ShareFile servers, and the like. SaaS applications may include Salesforce, and the like. Windows application servers may include any application server that is built to provide applications that are intended to run on a local Windows operating system, and the like. The enterprise resources 504 may be premise-based resources, cloud-based resources, and the like. The enterprise resources 504 may be accessed by the mobile device 502 directly or through the access gateway 560. The enterprise resources 504 may be accessed by the mobile device 502 via the transport network 562.

The enterprise services 508 may include authentication services 558, threat detection services 564, device manager services 524, file sharing services 568, policy manager services 570, social integration services 572, application controller services 574, and the like. Authentication services 558 may include user authentication services, device authentication services, application authentication services, data authentication services, and the like. Authentication services 558 may use certificates. The certificates may be stored on the mobile device 502, by the enterprise resources 504, and the like. The certificates stored on the mobile device 502 may be stored in an encrypted location on the mobile device 502, the certificate may be temporarily stored on the mobile device 502 for use at the time of authentication, and the like. Threat detection services 564 may include intrusion detection services, unauthorized access attempt detection services, and the like. Unauthorized access attempt detection services may include unauthorized attempts to access devices, applications, data, and the like. Device management services 524 may include configuration, provisioning, security, support, monitoring, reporting, and decommissioning services. File sharing services 568 may include file management services, file storage services, file collaboration services, and the like. Policy manager services 570 may include device policy manager services, application policy manager services, data policy manager services, and the like. Social integration services 572 may include contact integration services, collaboration services, integration with social networks such as Facebook, Twitter, and LinkedIn, and the like. Application controller services 574 may include management services, provisioning services, deployment services, assignment services, revocation services, wrapping services, and the like.

The enterprise mobility technical architecture 500 may include an application store 578. The application store 578 may include unwrapped applications 580, pre-wrapped applications 582, and the like. Applications may be populated in the application store 578 from the application controller 574. The application store 578 may be accessed by the mobile device 502 through the access gateway 560, through the public Internet 548, or the like. The application store 578 may be provided with an intuitive and easy to use user interface.

A software development kit 584 may provide a user the capability to secure applications selected by the user by wrapping the application as described previously in this description. An application that has been wrapped using the software development kit 584 may then be made available to the mobile device 502 by populating it in the application store 578 using the application controller 574.

The enterprise mobility technical architecture 500 may include a management and analytics capability 588. The management and analytics capability 588 may provide information related to how resources are used, how often resources are used, and the like. Resources may include devices, applications, data, and the like. How resources are used may include which devices download which applications, which applications access which data, and the like. How often resources are used may include how often an application has been downloaded, how many times a specific set of data has been accessed by an application, and the like.

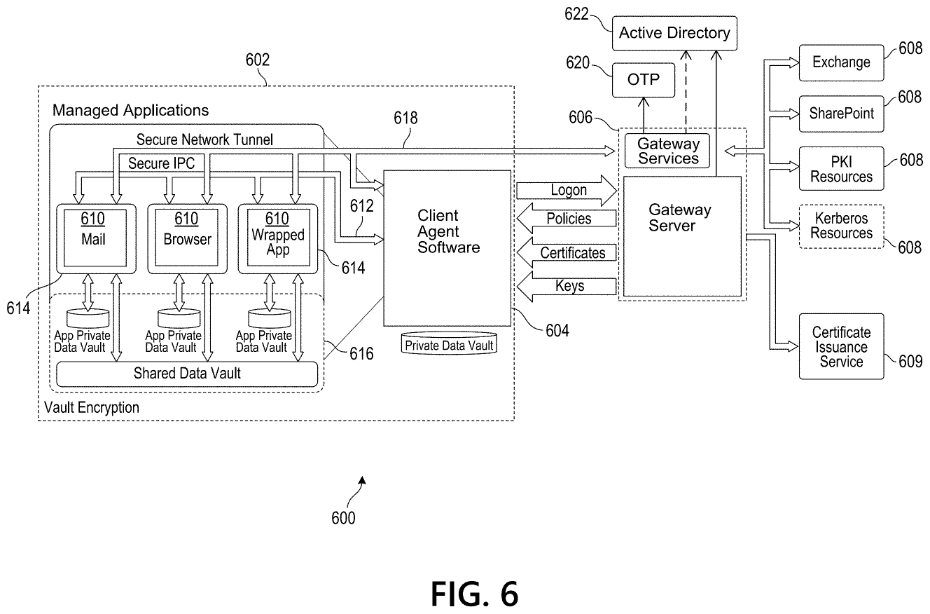

FIG. 6 is another illustrative enterprise mobility management system 600. Some of the components of the mobility management system 500 described above with reference to FIG. 5 have been omitted for the sake of simplicity. The architecture of the system 600 depicted in FIG. 6 is similar in many respects to the architecture of the system 500 described above with reference to FIG. 5 and may include additional features not mentioned above.

In this case, the left hand side represents an enrolled mobile device 602 with a client agent 604, which interacts with gateway server 606 (which includes Access Gateway and application controller functionality) to access various enterprise resources 608 and services 609 such as Exchange, Sharepoint, public-key infrastructure (PM) Resources, Kerberos Resources, Certificate Issuance service, as shown on the right hand side above. Although not specifically shown, the mobile device 602 may also interact with an enterprise application store (StoreFront) for the selection and downloading of applications.

The client agent 604 acts as the UI (user interface) intermediary for Windows apps/desktops hosted in an Enterprise data center, which are accessed using the High-Definition User Experience (HDX)/ICA display remoting protocol. The client agent 604 also supports the installation and management of native applications on the mobile device 602, such as native iOS or Android applications. For example, the managed applications 610 (mail, browser, wrapped application) shown in the figure above are all native applications that execute locally on the mobile device 602. Client agent 604 and application management framework of this architecture act to provide policy driven management capabilities and features such as connectivity and SSO (single sign on) to enterprise resources/services 608. The client agent 604 handles primary user authentication to the enterprise, normally to Access Gateway (AG) 606 with SSO to other gateway server components. The client agent 604 obtains policies from gateway server 606 to control the behavior of the managed applications 610 on the mobile device 602.

The Secure InterProcess Communication (IPC) links 612 between the native applications 610 and client agent 604 represent a management channel, which may allow a client agent to supply policies to be enforced by the application management framework 614 “wrapping” each application. The IPC channel 612 may also allow client agent 604 to supply credential and authentication information that enables connectivity and SSO to enterprise resources 608. Finally, the IPC channel 612 may allow the application management framework 614 to invoke user interface functions implemented by client agent 604, such as online and offline authentication.

Communications between the client agent 604 and gateway server 606 are essentially an extension of the management channel from the application management framework 614 wrapping each native managed application 610. The application management framework 614 may request policy information from client agent 604, which in turn may request it from gateway server 606. The application management framework 614 may request authentication, and client agent 604 may log into the gateway services part of gateway server 606 (for example, Citrix Gateway). Client agent 604 may also call supporting services on gateway server 606, which may produce input material to derive encryption keys for the local data vaults 616, or may provide client certificates which may enable direct authentication to PKI protected resources, as more fully explained below.

In more detail, the application management framework 614 “wraps” each managed application 610. This may be incorporated via an explicit build step, or via a post-build processing step. The application management framework 614 may “pair” with client agent 604 on first launch of an application 610 to initialize the Secure IPC channel 612 and obtain the policy for that application. The application management framework 614 may enforce relevant portions of the policy that apply locally, such as the client agent login dependencies and some of the containment policies that restrict how local OS services may be used, or how they may interact with the managed application 610.

The application management framework 614 may use services provided by client agent 604 over the Secure IPC channel 612 to facilitate authentication and internal network access. Key management for the private and shared data vaults 616 (containers) may be also managed by appropriate interactions between the managed applications 610 and client agent 604. Vaults 616 may be available only after online authentication, or may be made available after offline authentication if allowed by policy. First use of vaults 616 may require online authentication, and offline access may be limited to at most the policy refresh period before online authentication is again required.

Network access to internal resources may occur directly from individual managed applications 610 through Access Gateway 606. The application management framework 614 may be responsible for orchestrating the network access on behalf of each managed application 610. Client agent 604 may facilitate these network connections by providing suitable time limited secondary credentials obtained following online authentication. Multiple modes of network connection may be used, such as reverse web proxy connections and end-to-end VPN-style tunnels 618.

The Mail and Browser managed applications 610 have special status and may make use of facilities that might not be generally available to arbitrary wrapped applications. For example, the Mail application 610 may use a special background network access mechanism that allows it to access an Exchange server 608 over an extended period of time without requiring a full AG logon. The Browser application 610 may use multiple private data vaults 616 to segregate different kinds of data.

This architecture may support the incorporation of various other security features. For example, gateway server 606 (including its gateway services) in some cases might not need to validate active directory (AD) passwords. It can be left to the discretion of an enterprise whether an AD password may be used as an authentication factor for some users in some situations. Different authentication methods may be used if a user is online or offline (i.e., connected or not connected to a network).

Step up authentication is a feature wherein gateway server 606 may identify managed native applications 610 that are allowed to have access to highly classified data requiring strong authentication, and ensure that access to these applications is only permitted after performing appropriate authentication, even if this means a re-authentication is required by the user after a prior weaker level of login.

Another security feature of this solution is the encryption of the data vaults 616 (containers) on the mobile device 602. The vaults 616 may be encrypted so that all on-device data including files, databases, and configurations are protected. For on-line vaults, the keys may be stored on the server (gateway server 606), and for off-line vaults, a local copy of the keys may be protected by a user password or biometric validation. If or when data is stored locally on the mobile device 602 in the secure container 616, it may be preferred that a minimum of AES 256 encryption algorithm be utilized.

Other secure container features may also be implemented. For example, a logging feature may be included, wherein security events happening inside a managed application 610 may be logged and reported to the backend. Data wiping may be supported, such as if or when the managed application 610 detects tampering, associated encryption keys may be written over with random data, leaving no hint on the file system that user data was destroyed. Screenshot protection may be another feature, where an application may prevent any data from being stored in screenshots. For example, the key window's hidden property may be set to YES. This may cause whatever content is currently displayed on the screen to be hidden, resulting in a blank screenshot where any content would normally reside.

Local data transfer may be prevented, such as by preventing any data from being locally transferred outside the application container, e.g., by copying it or sending it to an external application. A keyboard cache feature may operate to disable the autocorrect functionality for sensitive text fields. SSL certificate validation may be operable so the application specifically validates the server SSL certificate instead of it being stored in the keychain. An encryption key generation feature may be used such that the key used to encrypt data on the mobile device 602 is generated using a passphrase or biometric data supplied by the user (if offline access is required). It may be XORed with another key randomly generated and stored on the server side if offline access is not required. Key Derivation functions may operate such that keys generated from the user password use KDFs (key derivation functions, notably Password-Based Key Derivation Function 2 (PBKDF2)) rather than creating a cryptographic hash of it. The latter makes a key susceptible to brute force or dictionary attacks.

Further, one or more initialization vectors may be used in encryption methods. An initialization vector will cause multiple copies of the same encrypted data to yield different cipher text output, preventing both replay and cryptanalytic attacks. This will also prevent an attacker from decrypting any data even with a stolen encryption key. Further, authentication then decryption may be used, wherein application data is decrypted only after the user has authenticated within the application. Another feature may relate to sensitive data in memory, which may be kept in memory (and not in disk) only when it's needed. For example, login credentials may be wiped from memory after login, and encryption keys and other data inside objective-C instance variables are not stored, as they may be easily referenced. Instead, memory may be manually allocated for these.

An inactivity timeout may be implemented, wherein after a policy-defined period of inactivity, a user session is terminated.

Data leakage from the application management framework 614 may be prevented in other ways. For example, if or when a managed application 610 is put in the background, the memory may be cleared after a predetermined (configurable) time period. When backgrounded, a snapshot may be taken of the last displayed screen of the application to fasten the foregrounding process. The screenshot may contain confidential data and hence should be cleared.

Another security feature may relate to the use of an OTP (one time password) 620 without the use of an AD (active directory) 622 password for access to one or more applications. In some cases, some users do not know (or are not permitted to know) their AD password, so these users may authenticate using an OTP 620 such as by using a hardware OTP system like SecurID (OTPs may be provided by different vendors also, such as Entrust or Gemalto). In some cases, after a user authenticates with a user ID, a text may be sent to the user with an OTP 620. In some cases, this may be implemented only for online use, with a prompt being a single field.

An offline password may be implemented for offline authentication for those managed applications 610 for which offline use is permitted via enterprise policy. For example, an enterprise may want StoreFront to be accessed in this manner In this case, the client agent 604 may require the user to set a custom offline password and the AD password is not used. Gateway server 606 may provide policies to control and enforce password standards with respect to the minimum length, character class composition, and age of passwords, such as described by the standard Windows Server password complexity requirements, although these requirements may be modified.

Another feature may relate to the enablement of a client side certificate for certain applications 610 as secondary credentials (for the purpose of accessing PM protected web resources via the application management framework micro VPN feature). For example, a managed application 610 may utilize such a certificate. In this case, certificate-based authentication using ActiveSync protocol may be supported, wherein a certificate from the client agent 604 may be retrieved by gateway server 606 and used in a keychain. Each managed application 610 may have one associated client certificate, identified by a label that is defined in gateway server 606.

Gateway server 606 may interact with an enterprise special purpose web service to support the issuance of client certificates to allow relevant managed applications to authenticate to internal PM protected resources.

The client agent 604 and the application management framework 614 may be enhanced to support obtaining and using client certificates for authentication to internal PM protected network resources. More than one certificate may be supported, such as to match various levels of security and/or separation requirements. The certificates may be used by the Mail and Browser managed applications 610, and ultimately by arbitrary wrapped applications 610 (provided those applications use web service style communication patterns where it is reasonable for the application management framework to mediate HTTPS requests).

Application management client certificate support on iOS may rely on importing a public-key cryptography standards (PKCS) 12 BLOB (Binary Large Object) into the iOS keychain in each managed application 610 for each period of use. Application management framework client certificate support may use a HTTPS implementation with private in-memory key storage. The client certificate might not be present in the iOS keychain and might not be persisted except potentially in “online-only” data value that is strongly protected.

Mutual SSL or TLS may also be implemented to provide additional security by requiring that a mobile device 602 is authenticated to the enterprise, and vice versa. Virtual smart cards for authentication to gateway server 606 may also be implemented.

Another feature may relate to application container locking and wiping, which may automatically occur upon jail-break or rooting detections, and occur as a pushed command from administration console, and may include a remote wipe functionality even when a managed application 610 is not running.

A multi-site architecture or configuration of enterprise application store and an application controller may be supported that allows users to be serviced from one of several different locations in case of failure.

In some cases, managed applications 610 may be allowed to access a certificate and private key via an API (for example, OpenSSL). Trusted managed applications 610 of an enterprise may be allowed to perform specific Public Key operations with an application's client certificate and private key. Various use cases may be identified and treated accordingly, such as if or when an application behaves like a browser and no certificate access is required, if or when an application reads a certificate for “who am I,” if or when an application uses the certificate to build a secure session token, and if or when an application uses private keys for digital signing of important data (e.g. transaction log) or for temporary data encryption.

Secure Token Transfer

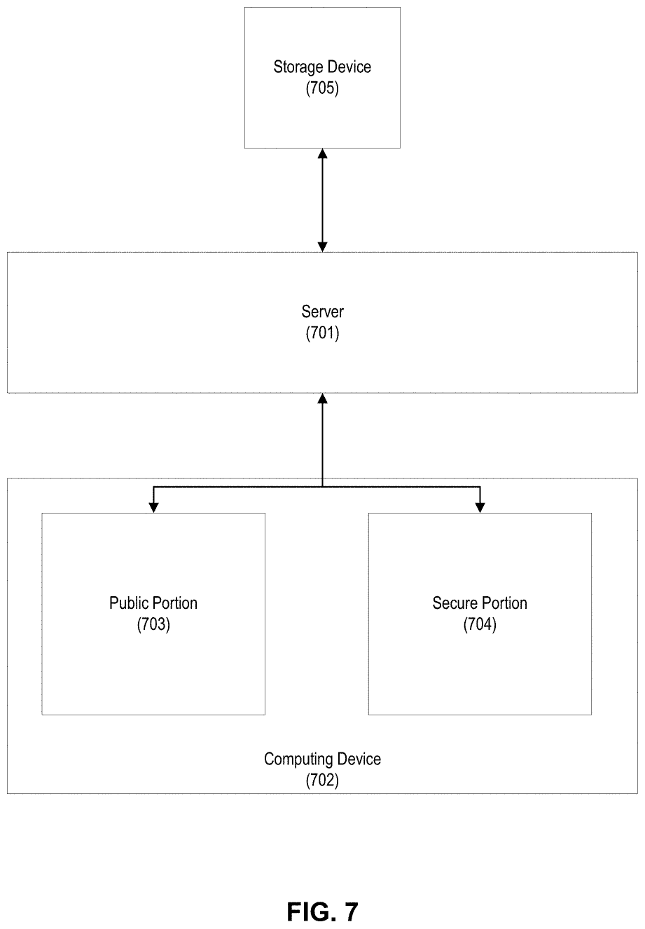

FIG. 7 depicts relationships between a sever 701 and a computing device 702. The computing device 702 is shown as having two portions: a public portion 703, and a secure portion 704. The server 701 is shown as communicatively coupled to a storage device 705. The public portion 703 and the secure portion 704 may be capable of communicating with the server 701, but the public portion 703 and the secure portion 704 are shown as not capable of communication with each other. The server 701 may be any computing device, such as any one of the network nodes 103, 105, 107, and 109, the management server 410, the gateway server 606, or the like. Similarly, the computing device 702 may be any one of the network nodes 103, 105, 107, and 109, the mobile device 602, or the like. The server 701, the public portion 703, the secure portion 704, and the storage device 705 may communicate via a network, such as the network 230, the public internet 548, or the like.

Different portions of the computing device 702, such as the public portion 703 and the secure portion 704, may be physical and/or logical divisions of the computing device 702, such as may be specified by an operating system. For example, the public portion 703 may correspond to the unmanaged partition 512, and the secure portion may correspond to the managed partition 510. A policy of the computing device may prevent the secure portion 704 from interacting with the public portion 703. This may advantageously improve the security of the secure portion 704. For example, if the computing device 702 is a mobile device (such as the mobile device 602), then the public portion 703 may comprise personal applications installed by the user, and the secure portion 704 may comprise applications installed by an employer of the user. Preventing the public portion 703 and the secure portion 704 from communicating and/or otherwise interacting may prevent exfiltration of data using, for example, compromised applications installed on the public portion 703.

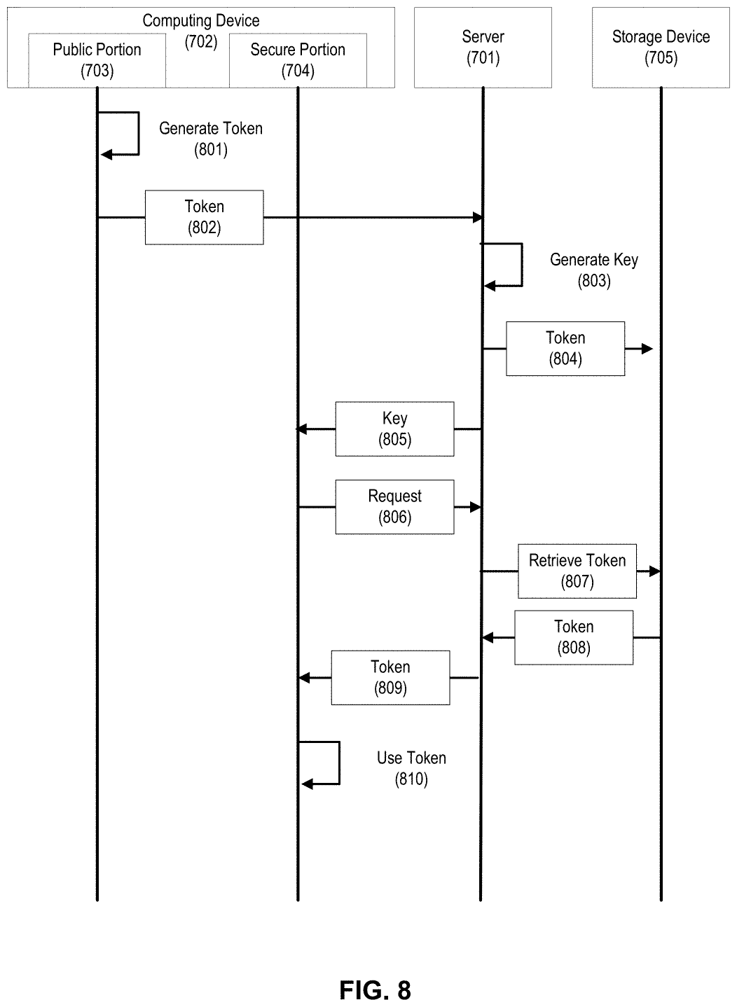

FIG. 8 is a flow diagram showing steps taken by the computing device 702 (including the public portion 703 and the secure portion 704), the server 701, and the storage device 705). The steps shown in FIG. 8 are illustrative, and additional steps may be performed before, during, or after the steps shown in FIG. 8. Moreover, steps depicted in FIG. 8 may be omitted and/or rearranged as desired.

In step 801, the public portion of the computing device 702 may generate a token. The token may be associated with authentication of the computing device 703. For example, a user of the computing device may provide authentication credentials to an application executing in the public portion 703 of the computing device 702, and the application may generate a token based on the authentication credentials.

A token may be any data which may be associated with a user of the computing device 702. The token may be generated based on authentication activity by the user. For example, a token may be generated based on a user authenticating with a username and a password and via the public portion 703 of the computing device 702. A token may correspond to execution of one or more applications in the public portion 703 of the computing device 702. For example, the token may indicate an operational status of an application and/or may contain data used by the application during execution.

In step 802, the public portion 703 of the computing device 702 may send the token to the server 701. The token may be sent using any network, such as via the public internet 548. Before sending the token, the computing device 702 may encrypt the token. In this manner, if the server 701 and/or the storage device 705 is untrusted, the token is encrypted to not expose sensitive information to either device.

In step 803, the server 701 may generate a key. The key may be generated based on the token received in step 802. Generating the key may comprise generating a cryptographically safe random secret key and/or a symmetric cypher key. Generating the key may comprise encrypting the token based on the key.

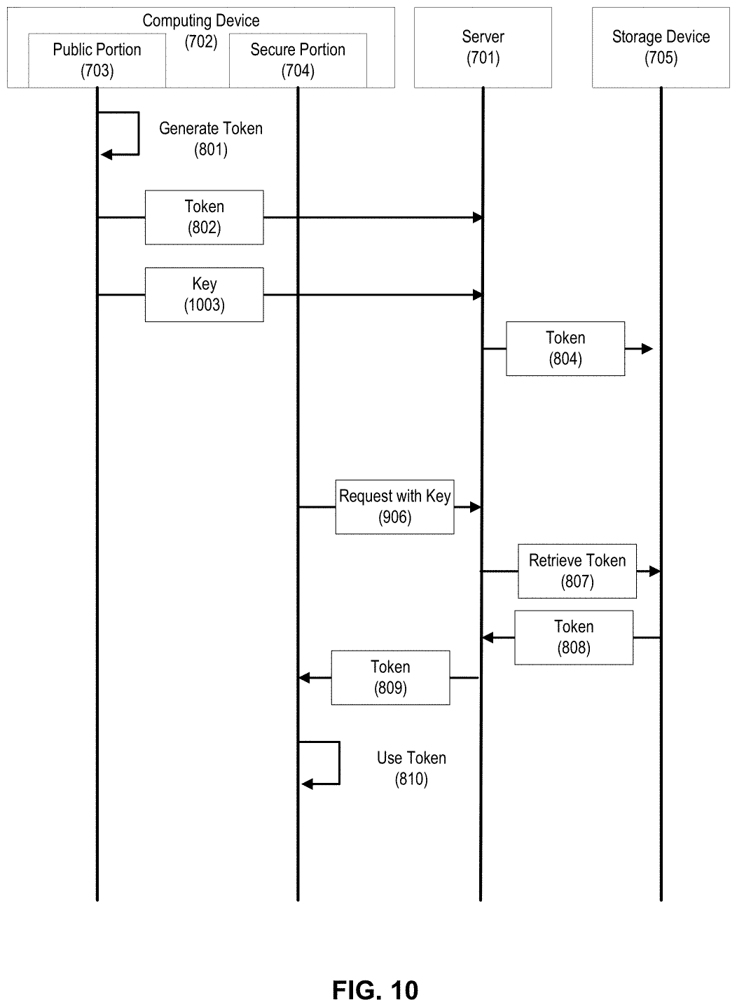

As part of generating the key, the server 701 may receive, from the computing device 702, user input comprising all or portions of the key. A user of the computing device 702 may be prompted to provide all or portions of a key to the server 701, such that the key may be selected by the user. In this manner, the key may comprise, for example, a four-digit number selected by a user of the computing device 702. This process is described in greater detail with respect to FIG. 10.

As part of generating the key, the server 701 may determine whether the key is represented in the database 705. As the token and the key may be stored in the database 705 such that the database 705 may be queried using the key to retrieve the token, having two different tokens stored using the same key may be undesirable and cause unpredictable results. For example, a user may receive the wrong token. As such, generating the key may comprise determining, using the database 705, a key that is not represented in the database 705. For example, a random key may be generated and/or a key may be received via user input, and the database 705 may be queried to determine whether a token is associated with that key. If so, the server 701 may cause generation of a new key.

In step 804, the server 701 may send the token to the storage device 705. The storage device 705 may be configured to store the token 804. The storage device 705 may store the token 804 such that the token is deleted after a predetermined period of time has elapsed. For example, the storage device 705 may delete received tokens after they have been stored for five minutes.

The storage device 705 may be configured to store the token as associated with the key, an identifier of a user of the computing device 702, an identifier of the computing device 702, and/or other information which may uniquely identify the user, the computing device 702, and/or the token. For example, the token may be stored as associated with a key and a Media Access Control (MAC) address of the computing device 702 such that other computing devices are incapable of retrieving the token, even if those computing devices have the key.

Once the storage device 705 has stored the token in step 704, the computing device 702 may delete the token from memory. For example, the token may be deleted from the public portion 703 of the computing device 702. In this manner, the token may be stored by the storage device 705, but not the computing device 702.

In step 805, the server 701 may send the key generated in step 803 to the secure portion 704 of the computing device 702. The sending of the key in step 805 may be performed in the same or a different method as compared to the sending of the token in step 802. For example, the token sent in step 802 may be sent via a text message, whereas the key sent in step 805 may be sent via an encrypted transmission over the Internet associated with a mobile device management system.

Sending the key to the secure portion 704 of the computing device 702 may comprise associating the key with an application. For example, an application may be compiled with and/or signed by a key, and the application may be sent to the secure portion 704 of the computing device 702. In this manner, the user of the computing device 702 need not manually enter the key at a later time, but may instead transmit the key by executing or otherwise operating the received application. For example, the server 701 may compile and sign an authentication application using the key generated in step 803 and transmit the authentication application to the secure portion 704 of the computing device 702 in step 805. Then, a user of the computing device 702 may execute the received authentication application in order to use the key for subsequent communications.

Sending the key may comprise sending the key to an operating system of the computing device 702. The secure portion 704 of the computing device 702 may be managed by a mobile device management application, which may be part of an operating system of the computing device 702. The mobile device management application may comprise, for example, the App Configuration functionality used in operating systems developed by Google Inc. of Mountain View, Calif. Such a mobile device management application may be configured to manage the secure portion 704 of the computing device 702 by, for example, installing and/or uninstalling applications in the secure portion 704 of the computing device 702. In this way, the key may be transmitted such that applications executing in the secure portion 704 of the computing device 702 may have access to the key via the mobile device management application.

Sending the key may comprise transmitting, to the secure portion 704 of the computing device 702, a URL which, when accessed by a web browser executing in the secure portion 704 of the computing device 702, provides the key to the secure portion 704 of the computing device 702. This process may be advantageous where, for example, the secure portion 704 of the computing device 702 has a secure web browser already installed. Sending the key may additionally and/or alternatively comprise embedding the key in an application such that, when a URL is accessed by the computing device 702, the computing device 702 downloads the application and thereby has access to the key. For example, the key may be embedded in a personalized version of an application that is stored on a server, and a URL may be sent to the computing device 702 such that the computing device 702 may download, via the URL, the personalized version of the application.

In step 806, the secure portion 704 of the computing device 702 may transmit a request for the token to the server 701. The request may comprise the key received in step 805. For example, if the key received in step 805 was in the form of an application signed by the key, then the request in 806 may comprise an indication that the secure portion 704 of the computing device 702 is executing an application signed by the key. The request may be additionally and/or alternatively transmitted by an application that has been compiled with and/or signed by the key.

In step 807, the server 701 may retrieve the token from the storage device 705. Retrieving the token from the storage device 705 may comprise using the key received along with the request in step 806 to query the storage device 705.

In step 808, the token may be retrieved from the storage device 705. Once retrieved from the storage device 705, the token may be deleted. Additionally and/or alternatively, the token may be deleted after a predetermined period of time and/or after a predetermined number of retrievals. In this manner, if the token may be used to authenticate a user, the likelihood that the token may be acquired by an unauthorized user is lessened.

In step 809, the server 701 may send the token to the secure portion 704 of the computing device 702. The transmission of the token to the secure portion 704 of the computing device 702 need not be in the same manner as the token was originally sent to the server 701 in step 802.

The token (e.g., the token stored in step 807, retrieved in step 808, and/or sent in 809) may be encrypted. Encrypting the token may advantageously improve security, as devices transmitting the token (e.g., the server 701 and/or any intermediary devices between the server 701 and the computing device 702) will thereby not have access to the unencrypted version of the token. The encryption of the token may be performed using keys generated from identifiers of one or more devices, such as the computing device 702. Additionally and/or alternatively, the encryption of the token may be performed using keys generated using an entropy provided by the end user. For example, a user of the computing device 702 may be prompted to input a string (e.g., one or more numbers such as a pin code, a temporary password, an arbitrary word, etc.) and that string may be used to encrypt and/or decrypt the token.

In step 810, the secure portion 704 of the computing device 702 may use the token. For example, the secure portion 704 of the computing device 702 may use the token to authenticate the secure portion 704 of the computing device 702 based on a previous authentication of the public portion 703 of the computing device 702. The secure portion 704 of the computing device 702 may use the key to decrypt all or portions of the token. For example, the token may have been encrypted, using a key, by the public portion 703 of the computing device 702, and the key may be used to decrypt the token.

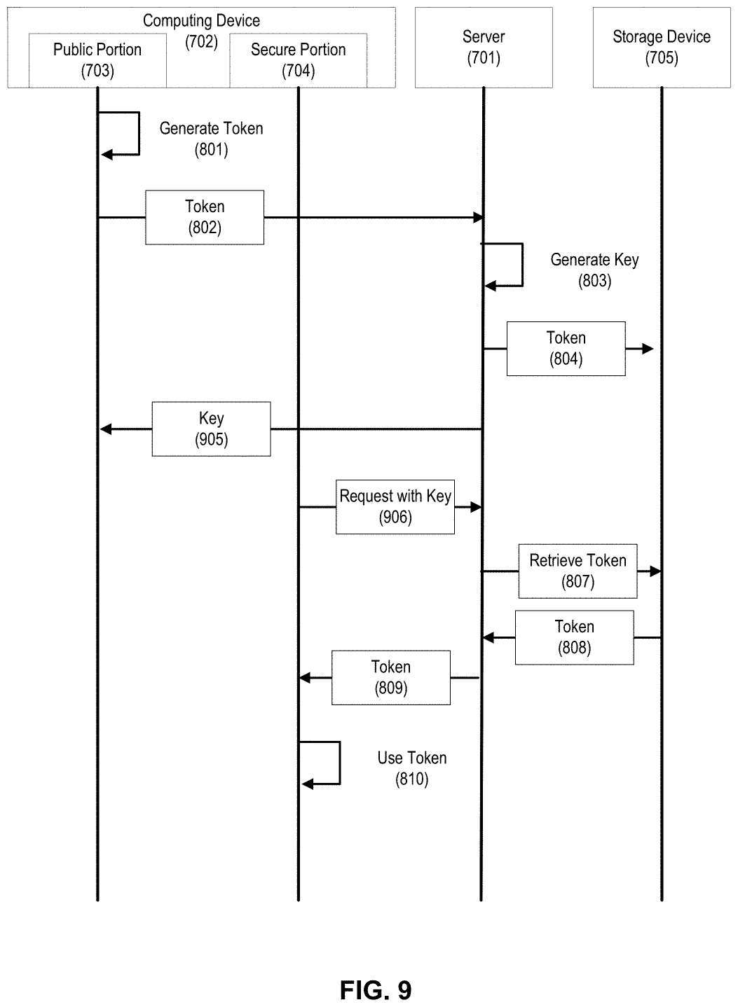

FIG. 9 depicts a modified version of FIG. 8 that shows a process where the user is provided the key to re-enter in the secure portion 704 of the computing device 702. In FIG. 9, steps 801-804 are the same. Step 905 shows the server 701 sending the key to the public portion 703 of the computing device 702. In this case, the key may be a short alphanumeric string (e.g., a series of numbers, a word, or the like) which may be remembered by the user of the computing device 702. Then, in step 906 and as part of sending a request for the token to the server 701 via the secure portion 704 of the computing device 702, the user may enter the key into a user interface of the computing device 702. For example, where step 801 involves the user, using the public portion 703 of the computing device 702, authenticating with an external service to generate the token, this process may allow the user to re-authenticate the secure portion 704 of the computing device 702 by entering in a relatively simpler and/or shorter key. Steps 807-810 of FIG. 9 may be the same or similar as shown in FIG. 8.

FIG. 10 depicts a modified version of FIG. 8 that shows a process where the user provides the key to later authenticate the secure portion 704 of the computing device 702. In FIG. 10, steps 801 and 802 may be the same or similar as in FIG. 8. In step 1003, the user may, using the public portion 703 of the computing device 702, provide a key to the server 701. Providing the key may comprise entering in a password or other alphanumeric string as user input, which may be transmitted to the server 701. In such a circumstance, the server 701 may query or otherwise check the storage device 705 to ensure that the key is unique, such that two different tokens are not stored under the same key. Step 906 may be the same as described with respect to FIG. 9. Steps 807-810 of FIG. 9 may be the same or similar as shown in FIG. 8.

The following paragraphs (M1) through (M20) describe examples of methods that may be implemented in accordance with the present disclosure.

(M1) A method comprising receiving, by a server and from a first application executing on a first portion of a computing device, a token; generating a key corresponding to the token; storing, in a database, the token and the key; sending, by the server and to a second portion of the computing device, the key, wherein the second portion of the computing device is prevented by a security policy from interacting with the first portion of the computing device; receiving, from the second portion of the computing device, a request for the token, wherein the request comprises the key; retrieving, from the database and using the key, the token; and sending, to the second portion of the computing device, the token

(M2) A method may be performed as described in paragraph (M1) wherein sending the key comprises: compiling a second application, wherein the compiled application comprises the key; and sending, to the second portion of the computing device, the second application.

(M3) A method may be performed as described in paragraph (M1) wherein compiling the second application comprises signing the second application with the key.

(M4) A method may be performed as described in paragraph (M1) wherein sending the key comprises: sending, to a mobile device management application configured to manage the second portion of the computing device, the key.

(M5) A method may be performed as described in paragraph (M1) wherein sending the key comprises: sending, to the second portion of the computing device, a Uniform Resource Locator (URL) which, when accessed by a web browser executing in the second portion of the computing device, provides the key.

(M6) A method may be performed as described in paragraph (M1) wherein generating the key comprises: receiving, from the computing device, user input comprising at least a portion of the key.

(M7) A method may be performed as described in paragraph (M1) wherein generating the key comprises: generating the key based on a determination that the key is not represented in the database.

(M8) A method may be performed as described in paragraph (M1) wherein storing the token in the database comprises: configuring the database to delete the token after a predetermined time period.

(M9) A method may be performed as described in paragraph (M1) wherein retrieving the token comprises: querying, using the key and a user identifier associated with the computing device, the database for the token.

(M10) A method comprising sending, to a server and from a first application executing on a first portion of a computing device, a token; receiving, in a second portion of the computing device and in response to sending the token, a key, wherein the second portion of the computing device is prevented by a security policy from interacting with the first portion of the computing device; sending, from the second portion of the computing device and to the server, a request for the token, wherein the request comprises the key; receiving, from the server and in the second portion of the computing device, the token; and decrypting, using the key, the token.

(M11) A method may be performed as described in paragraph (M10) wherein receiving the key comprises: receiving a second application comprising the key; and executing the second application, wherein the second application is configured to send the request for the token.

(M12) A method may be performed as described in paragraph (M10) wherein sending the request for the token comprises: receiving, via a second application executing in the second portion of the computing device, user input comprising at least a portion of the key.

(M13) A method may be performed as described in paragraph (M10) the method further comprising: encrypting the token before sending the token to the server.

(M14) A method may be performed as described in paragraph (M10) the method further comprising: deleting, after receiving the key, the token from storage.

(M15) A method comprising receiving, by a server and from a first application executing on a first portion of a computing device, a token; signing, by the server, a second application with a key corresponding to the token; causing a second portion of the computing device to execute the second application, wherein the second portion of the computing device is prevented by a security policy from interacting with the first portion of the computing device; receiving, by the server and from the second application, a request for the token; and sending, by the server and to the second portion of the computing device, the token.

(M16) A method may be performed as described in paragraph (M15) wherein the request for the token comprises at least a portion of the key.

(M17) A method may be performed as described in paragraph (M15) wherein signing the second application with the key comprises: compiling the second application with the key.

(M18) A method may be performed as described in paragraph (M15) wherein further comprising: storing the token and the key; and deleting the token and the key after a predetermined time period.

(M19) A method may be performed as described in paragraph (M15) further comprising: receiving, from the computing device, user input comprising at least a portion of the key.

(M20) A method may be performed as described in paragraph (M15) further comprising: generating, after receiving the token, the key.

The following paragraphs (A1) through (A20) describe examples of apparatuses that may be implemented in accordance with the present disclosure.

(A1) An apparatus comprising one or more processors and memory storing instructions that, when executed by the one or more processors, cause the apparatus to receive, from a first application executing on a first portion of a computing device, a token; generate a key corresponding to the token; store, in a database, the token and the key; send, to a second portion of the computing device, the key, wherein the second portion of the computing device is prevented by a security policy from interacting with the first portion of the computing device; receive, from the second portion of the computing device, a request for the token, wherein the request comprises the key; retrieve, from the database and using the key, the token; and send, to the second portion of the computing device, the token

(A2) An apparatus as described in paragraph (A1) wherein the instructions, when executed by the one or more processors, cause the apparatus to send the key by causing the apparatus to compile a second application, wherein the compiled application comprises the key; and send, to the second portion of the computing device, the second application.

(A3) An apparatus as described in paragraph (A1) wherein the instructions, when executed by the one or more processors, cause the apparatus to compile the second application by causing the apparatus to sign the second application with the key.

(A4) An apparatus as described in paragraph (A1) wherein the instructions, when executed by the one or more processors, cause the apparatus to send the key by causing the apparatus to: send, to a mobile device management application configured to manage the second portion of the computing device, the key.

(A5) An apparatus as described in paragraph (A1) wherein the instructions, when executed by the one or more processors, cause the apparatus to send the key by causing the apparatus to send, to the second portion of the computing device, a Uniform Resource Locator (URL) which, when accessed by a web browser executing in the second portion of the computing device, provides the key.

(A6) An apparatus as described in paragraph (A1) wherein the instructions, when executed by the one or more processors, cause the apparatus to generate the key by causing the apparatus to receive, from the computing device, user input comprising at least a portion of the key.

(A7) An apparatus as described in paragraph (A1) wherein the instructions, when executed by the one or more processors, cause the apparatus to generate the key by causing the apparatus to generate the key based on a determination that the key is not represented in the database.

(A8) An apparatus as described in paragraph (A1) wherein the instructions, when executed by the one or more processors, cause the apparatus to store the token in the database by causing the apparatus to configure the database to delete the token after a predetermined time period.

(A9) An apparatus as described in paragraph (A1) wherein the instructions, when executed by the one or more processors, cause the apparatus to retrieve the token by causing the apparatus to query, using the key and a user identifier associated with the computing device, the database for the token.

(A10) An apparatus comprising one or more processors and memory storing instructions that, when executed by the one or more processors, cause the apparatus to send, to a server and from a first application executing on a first portion of a computing device, a token; receive, in a second portion of the computing device and in response to sending the token, a key, wherein the second portion of the computing device is prevented by a security policy from interacting with the first portion of the computing device; send, from the second portion of the computing device and to the server, a request for the token, wherein the request comprises the key; receive, from the server and in the second portion of the computing device, the token; and decrypt, using the key, the token.

(A11) An apparatus as described in paragraph (A10) wherein the instructions, when executed by the one or more processors, cause the apparatus to receive the key by causing the apparatus to receive a second application comprising the key; and execute the second application, wherein the second application is configured to send the request for the token.

(A12) An apparatus as described in paragraph (A10) wherein the instructions, when executed by the one or more processors, cause the apparatus to send the request for the token by causing the apparatus to receive, via a second application executing in the second portion of the computing device, user input comprising at least a portion of the key.

(A13) An apparatus as described in paragraph (A10) wherein the instructions, when executed by the one or more processors, cause the apparatus to encrypt the token before sending the token to the server.

(A14) An apparatus as described in paragraph (A10) wherein the instructions, when executed by the one or more processors, cause the apparatus to delete, after receiving the key, the token from storage.

(A15) An apparatus comprising one or more processors and memory storing instructions that, when executed by the one or more processors, cause the apparatus to receive, from a first application executing on a first portion of a computing device, a token; sign a second application with a key corresponding to the token; cause a second portion of the computing device to execute the second application, wherein the second portion of the computing device is prevented by a security policy from interacting with the first portion of the computing device; receive, from the second application, a request for the token; and send, to the second portion of the computing device, the token.

(A16) An apparatus as described in paragraph (A15) wherein the request for the token comprises at least a portion of the key.

(A17) An apparatus as described in paragraph (A15) wherein the instructions, when executed by the one or more processors, cause the apparatus to sign the second application with the key by causing the apparatus to compile the second application with the key.

(A18) An apparatus as described in paragraph (A15) wherein the instructions, when executed by the one or more processors, cause the apparatus to store the token and the key; and delete the token and the key after a predetermined time period.

(A19) An apparatus as described in paragraph (A15) wherein the instructions, when executed by the one or more processors, cause the apparatus to receive, from the computing device, user input comprising at least a portion of the key.

(A20) An apparatus as described in paragraph (A15) wherein the instructions, when executed by the one or more processors, cause the apparatus to generate, after receiving the token, the key.

The following paragraphs (CRM1) through (CRM20) describe examples of computer-readable media that may be implemented in accordance with the present disclosure.

(CRM1) A non-transitory computer-readable medium storing instructions that, when executed, cause an apparatus to receive, from a first application executing on a first portion of a computing device, a token; generate a key corresponding to the token; store, in a database, the token and the key; send, to a second portion of the computing device, the key, wherein the second portion of the computing device is prevented by a security policy from interacting with the first portion of the computing device; receive, from the second portion of the computing device, a request for the token, wherein the request comprises the key; retrieve, from the database and using the key, the token; and send, to the second portion of the computing device, the token

(CRM2) A non-transitory computer-readable medium as described in paragraph (CRM1) wherein the instructions, when executed, cause the apparatus to send the key by causing the apparatus to compile a second application, wherein the compiled application comprises the key; and send, to the second portion of the computing device, the second application.

(CRM3) A non-transitory computer-readable medium as described in paragraph (CRM1) wherein the instructions, when executed, cause the apparatus to compile the second application by causing the apparatus to sign the second application with the key.

(CRM4) A non-transitory computer-readable medium as described in paragraph (CRM1) wherein the instructions, when executed, cause the apparatus to send the key by causing the apparatus to: send, to a mobile device management application configured to manage the second portion of the computing device, the key.

(CRM5) A non-transitory computer-readable medium as described in paragraph (CRM1) wherein the instructions, when executed, cause the apparatus to send the key by causing the apparatus to send, to the second portion of the computing device, a Uniform Resource Locator (URL) which, when accessed by a web browser executing in the second portion of the computing device, provides the key.

(CRM6) A non-transitory computer-readable medium as described in paragraph (CRM1) wherein the instructions, when executed, cause the apparatus to generate the key by causing the apparatus to receive, from the computing device, user input comprising at least a portion of the key.

(CRM7) A non-transitory computer-readable medium as described in paragraph (CRM1) wherein the instructions, when executed, cause the apparatus to generate the key by causing the apparatus to generate the key based on a determination that the key is not represented in the database.

(CRM8) A non-transitory computer-readable medium as described in paragraph (CRM1) wherein the instructions, when executed, cause the apparatus to store the token in the database by causing the apparatus to configure the database to delete the token after a predetermined time period.

(CRM9) A non-transitory computer-readable medium as described in paragraph (CRM1) wherein the instructions, when executed, cause the apparatus to retrieve the token by causing the apparatus to query, using the key and a user identifier associated with the computing device, the database for the token.

(CRM10) A non-transitory computer-readable medium storing instructions that, when executed, cause an apparatus to send, to a server and from a first application executing on a first portion of a computing device, a token; receive, in a second portion of the computing device and in response to sending the token, a key, wherein the second portion of the computing device is prevented by a security policy from interacting with the first portion of the computing device; send, from the second portion of the computing device and to the server, a request for the token, wherein the request comprises the key; receive, from the server and in the second portion of the computing device, the token; and decrypt, using the key, the token.

(CRM11) A non-transitory computer-readable medium as described in paragraph (CRM10) wherein the instructions, when executed, cause the apparatus to receive the key by causing the apparatus to receive a second application comprising the key; and execute the second application, wherein the second application is configured to send the request for the token.

(CRM12) A non-transitory computer-readable medium as described in paragraph (CRM10) wherein the instructions, when executed, cause the apparatus to send the request for the token by causing the apparatus to receive, via a second application executing in the second portion of the computing device, user input comprising at least a portion of the key.

(CRM13) A non-transitory computer-readable medium as described in paragraph (CRM10) wherein the instructions, when executed, cause the apparatus to encrypt the token before sending the token to the server.

(CRM14) A non-transitory computer-readable medium as described in paragraph (CRM10) wherein the instructions, when executed, cause the apparatus to delete, after receiving the key, the token from storage.

(CRM15) A non-transitory computer-readable medium storing instructions that, when executed, cause an apparatus to receive, from a first application executing on a first portion of a computing device, a token; sign a second application with a key corresponding to the token; cause a second portion of the computing device to execute the second application, wherein the second portion of the computing device is prevented by a security policy from interacting with the first portion of the computing device; receive, from the second application, a request for the token; and send, to the second portion of the computing device, the token.

(CRM16) A non-transitory computer-readable medium as described in paragraph (CRM15) wherein the request for the token comprises at least a portion of the key.

(CRM17) A non-transitory computer-readable medium as described in paragraph (CRM15) wherein the instructions, when executed, cause the apparatus to sign the second application with the key by causing the apparatus to compile the second application with the key.

(CRM18) A non-transitory computer-readable medium as described in paragraph (CRM15) wherein the instructions, when executed, cause the apparatus to store the token and the key; and delete the token and the key after a predetermined time period.

(CRM19) A non-transitory computer-readable medium as described in paragraph (CRM15) wherein the instructions, when executed, cause the apparatus to receive, from the computing device, user input comprising at least a portion of the key.

(CRM20) A non-transitory computer-readable medium as described in paragraph (CRM15) wherein the instructions, when executed, cause the apparatus to generate, after receiving the token, the key.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
receiving, by a server and from a first application executing on a first portion of a computing device, a token;
generating a key corresponding to the token;
storing, in a database, the token and the key;
sending, by the server and to a second portion of the computing device, the key, wherein the second portion of the computing device is prevented by a security policy from interacting with the first portion of the computing device;
receiving, from the second portion of the computing device, a request for the token, wherein the request comprises the key;
retrieving, from the database and using the key, the token; and
sending, to the second portion of the computing device, the token.

2. The method of claim 1, wherein sending the key comprises:
compiling a second application, wherein the compiled application comprises the key; and
sending, to the second portion of the computing device, the second application.

3. The method of claim 2, wherein compiling the second application comprises signing the second application with the key.

4. The method of claim 1, wherein sending the key comprises:
sending, to a mobile device management application configured to manage the second portion of the computing device, the key.

5. The method of claim 1, wherein sending the key comprises:
sending, to the second portion of the computing device, a Uniform Resource Locator (URL) which, when accessed by a web browser executing in the second portion of the computing device, provides the key.

6. The method of claim 1, wherein generating the key comprises:
receiving, from the computing device, user input comprising at least a portion of the key.

7. The method of claim 1, wherein generating the key comprises:
generating the key based on a determination that the key is not represented in the database.

8. The method of claim 1, wherein storing the token in the database comprises:
configuring the database to delete the token after a predetermined time period.

9. The method of claim 1, wherein retrieving the token comprises:
querying, using the key and a user identifier associated with the computing device, the database for the token.

10. A method comprising:
sending, to a server and from a first application executing on a first portion of a computing device, a token;
receiving, in a second portion of the computing device and in response to sending the token, a key, wherein the second portion of the computing device is prevented by a security policy from interacting with the first portion of the computing device;
sending, from the second portion of the computing device and to the server, a request for the token, wherein the request comprises the key;
receiving, from the server and in the second portion of the computing device, the token; and
decrypting, using the key, the token.

11. The method of claim 10, wherein receiving the key comprises:
receiving a second application comprising the key; and
executing the second application, wherein the second application is configured to send the request for the token.

12. The method of claim 10, wherein sending the request for the token comprises:
receiving, via a second application executing in the second portion of the computing device, user input comprising at least a portion of the key.

13. The method of claim 10, further comprising:
encrypting the token before sending the token to the server.

14. The method of claim 10, further comprising:
deleting, after receiving the key, the token from storage.

15. A method comprising:
receiving, by a server and from a first application executing on a first portion of a computing device, a token;
signing, by the server, a second application with a key corresponding to the token;
causing a second portion of the computing device to execute the second application, wherein the second portion of the computing device is prevented by a security policy from interacting with the first portion of the computing device;
receiving, by the server and from the second application, a request for the token; and
sending, by the server and to the second portion of the computing device, the token.

16. The method of claim 15, wherein the request for the token comprises at least a portion of the key.

17. The method of claim 15, wherein signing the second application with the key comprises:
compiling the second application with the key.

18. The method of claim 15, further comprising:
storing the token and the key; and
deleting the token and the key after a predetermined time period.

19. The method of claim 15, further comprising:
receiving, from the computing device, user input comprising at least a portion of the key.

20. The method of claim 15, further comprising:
generating, after receiving the token, the key.
